(19) United States
(12) Patent Application Publication
(10) Pub. No.: US 2014/0305836 A1
(43) Pub. Date: Oct. 16, 2014

(54) PILL BOX FOR AUTOMATIC PILL DISPENSER

(71) Applicant: HON HAI PRECISION INDUSTRY CO., LTD., New Taipei (TW)

(72) Inventor: KUO-MING LAI, New Taipei (TW)

(73) Assignee: HON HAI PRECISION INDUSTRY CO., LTD., New Taipei (TW)

(21) Appl. No.: 14/220,142

(22) Filed: Mar. 20, 2014

(30) Foreign Application Priority Data
Apr. 12, 2013 (TW) 102112995

(51) Int. Cl. A61J 1/03

(52) U.S. Cl. CPC A61J 1/03
USPC 206/540

(57) ABSTRACT

A pill box of an automatic pill dispenser includes a box body receiving a plurality pills, a base, a tray, and a vibration member. The tray is secured to the base. The box body is secured to the tray. The vibration member is located under the tray. The vibration member is vibrated to vibrate the tray and the box body, to separate the plurality of pills.

### FIELD

Embodiments of the present disclosure relate to pill boxes, and particularly to a pill box of an automatic pill dispenser.

### BACKGROUND

In current automatic pill dispensers, pills are taken out from a pill box one by one by an automatic arm. However, the pills can easily pile up, which may cause the automatic arm to fail to catch the pills. Two or more pills can easily stick together, which can cause the automatic arm to catch two or more pills at one time. Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of one embodiment of a pill box of an automatic pill dispenser.

FIG. 2 is similar to FIG. 1, but viewed from a different aspect.

FIG. 3 is an assembled, isometric view of the pill box of FIG. 1, showing a tray and a latching member in an initial position.

FIG. 4 is similar to FIG. 3, but viewed from a different aspect, showing a part of the pill box.

FIG. 5 is similar to FIG. 4, but showing the tray and the latching member in a vibration position.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

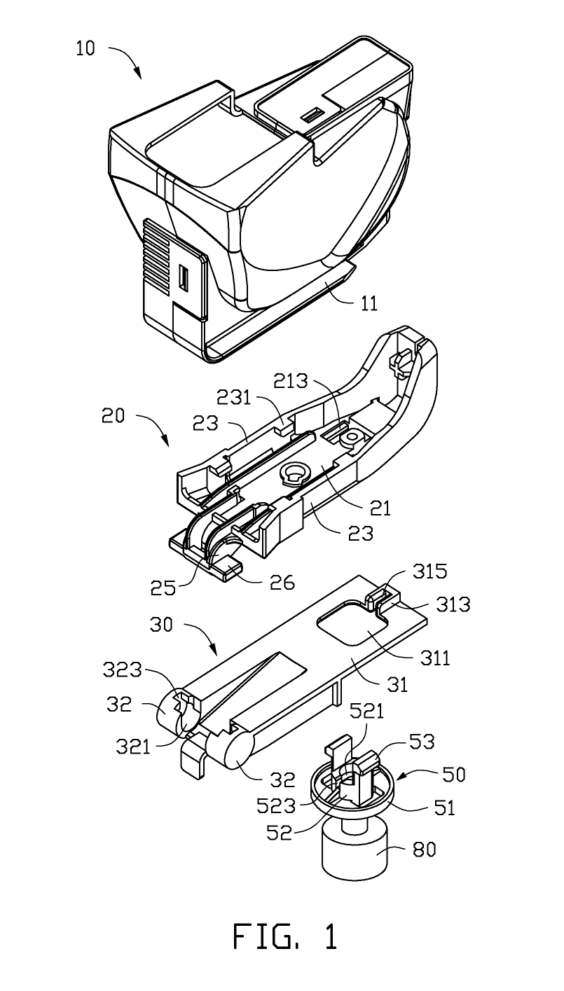

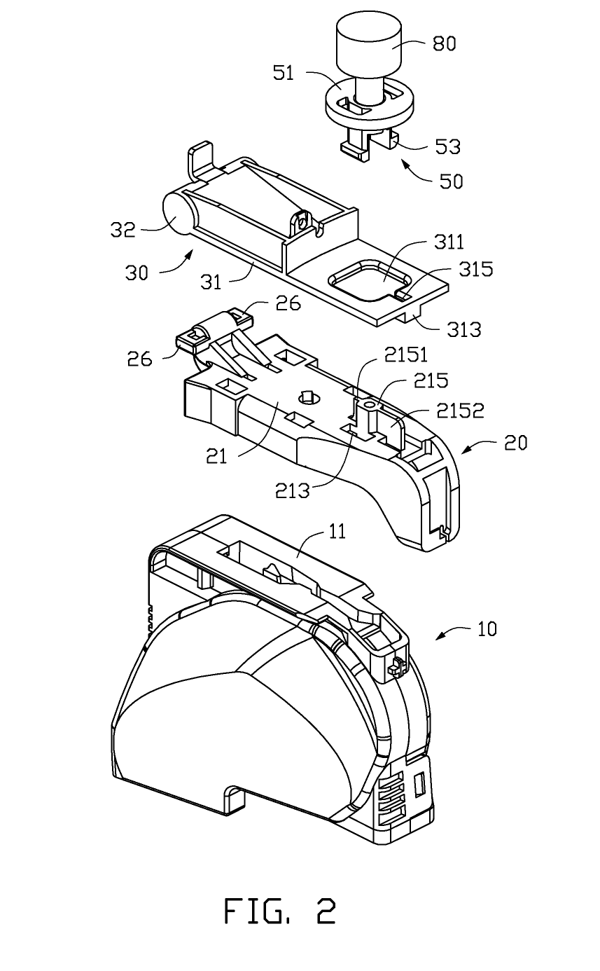

FIG. 1 and FIG. 2 show one embodiment of a pill box of an automatic pill dispenser. The pill box includes a box body 10, a tray 20, a base 30, and a latching member 50.

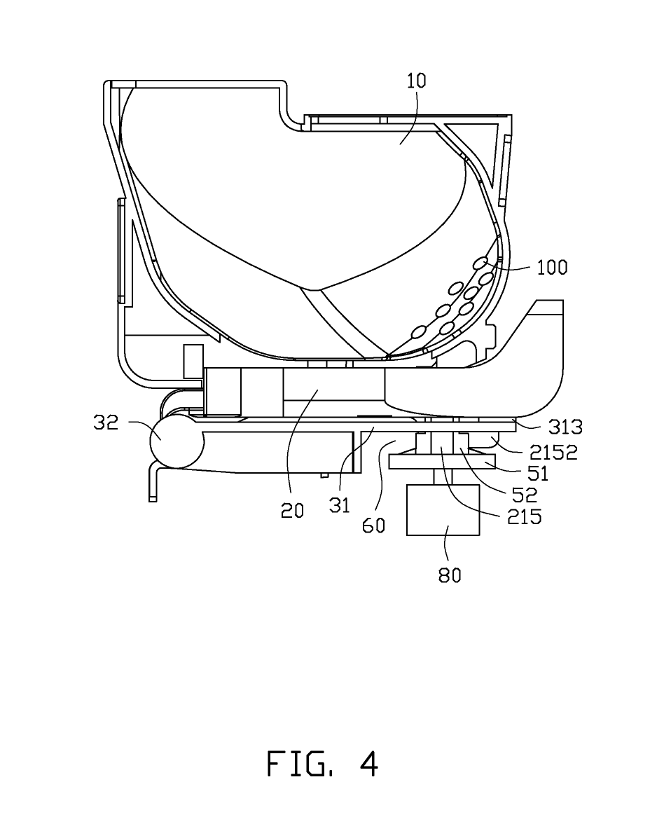

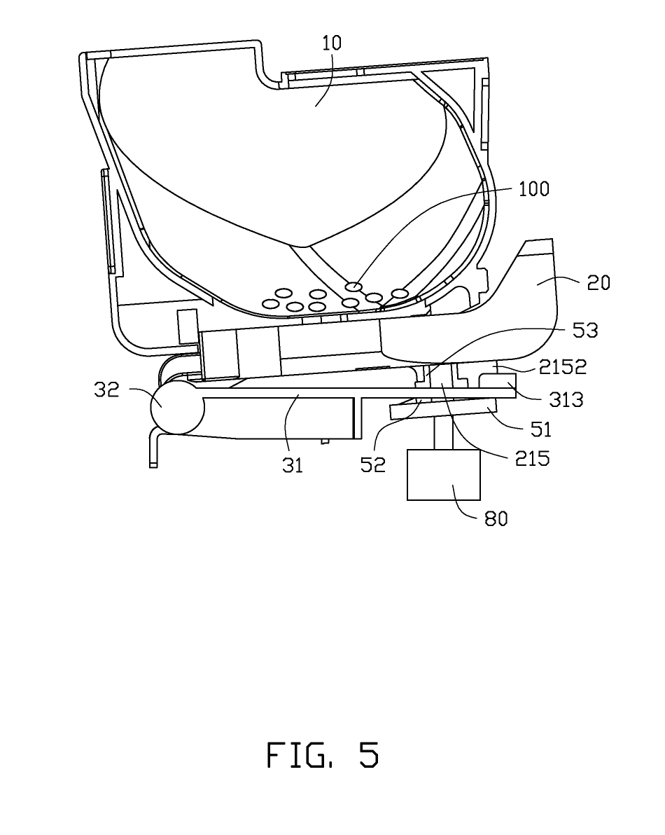

The box body 10 receives a plurality of pills 100 (shown in FIG. 4 and FIG. 5). A mounting piece 11 extends from each of opposite sides of a bottom portion of the box body 10.

The tray 20 secures the box body 10 and includes a tray plate 21 and two side plates 23 extending upwards from opposite edges of the tray plate 21. Two latching blocks 231 extend from each side plate 23 towards another side plate 23. In one embodiment, each latching block 231 is substantially perpendicular to the side plate 23. A connecting portion 25 extends downwards from a top surface of the tray plate 21. The connecting portion 25 is curved. A pivoting portion 26 extends from each of opposite ends of the connecting portion 25. The tray plate 21 defines two through holes 213. A protrusion 215 extends from a bottom surface of the tray plate 21, and the protrusion 215 is located between the two through holes 213. A first limiting piece 2151 extends from a first side of the protrusion 215. A second limiting piece 2152 extends from a second side of the protrusion 215. In one embodiment, each of the first limiting piece 2151 and the second limiting piece 2152 is substantially perpendicular to the tray plate 21. A length of the first limiting piece 2151 is less than a length of the second limiting piece 2152.

The base 30 includes a base plate 31 and two receiving portions 32 located in a side of the base plate 31. In one embodiment, each receiving portion 32 is columniform. Each receiving portion 32 defines a receiving slot 321 and a cutout 323. The cutout 323 is defined in a top portion of the receiving slot 321 and communicates with the receiving slot 321. The base plate 31 defines an opening 311. A boss 313 extends upwards from the base plate 31. The boss 313 defines a limiting slot 315 communicating with the opening 311.

The latching member 50 includes a limiting plate 51, a mounting portion 52 extending from the limiting plate 51, and two hooks 53 extending upwards from the mounting portion 52. The mounting portion 52 defines a mounting hole 521 and two latching slots 523. The mounting hole 521 is defined in a central portion of the mounting portion 52. The latching slots 523 extend through the mounting portion 52. The mounting hole 521 is used for receiving the protrusion 215. The two latching slots 523 are used for receiving the first limiting piece 2151 and the second limiting piece 2152.

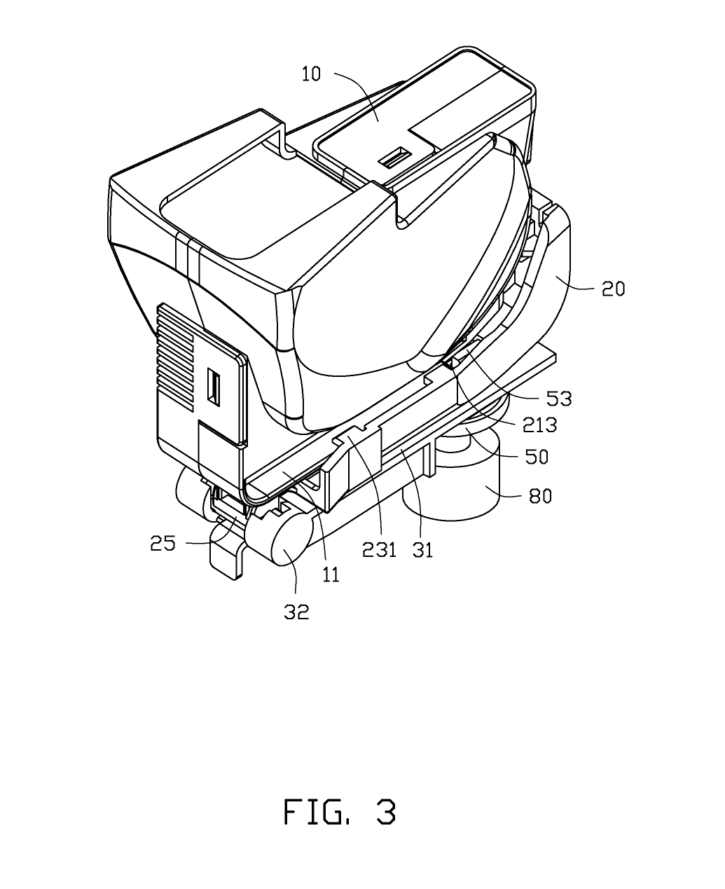

FIG. 3 and FIG. 4 show that in assembly, the tray 20 is slantingly moved to the base 30 to insert the pivoting portion 26 into the cutout 323. The tray 20 is rotated towards the base plate 31 so that the pivoting portion 26 is rotatably received in the receiving slot 321. The first limiting piece 2151 and the protrusion 215 are aligned with the opening 311. The second limiting piece 2152 is inserted into the limiting slot 315. The tray 20 is rotatable relative to the base 30 along the receiving slot 321. The latching member 50 is moved to extend the hooks 53 through the opening 311. The hooks 53 are elastically deformed towards each other until extending through the through holes 213. The hooks 53 rebound to engage with a top surface of the tray plate 21. The mounting pieces 11 are latched to the latching blocks 231 so that the box body 10 is secured to the tray 20. A vibration member 80 is connected under the latching member 50 and is vibrated to move the latching member 50 up and down. In this position, the tray 20 and the latching member 50 are located in an initial position, the limiting plate 51 is substantially parallel to the base plate 31, a gap 60 is defined between the limiting plate 51 and the base plate 31, and the tray plate 21 is substantially parallel to the base plate 31.

FIG. 4 shows that the pills 100 are moved to pile up at a second side of the box body 10 from a first side of the box body 10 because an automatic arm moves from the first side to the second side of the box body 10 when the automatic arm catches the pills 100. The first side of the box body 10 is adjacent to the pivoting portion 26. The second side of the box body 10 is away from the pivoting portion 26.

FIG. 5 shows that in use, the latching member 50 vibrates up and down under the action of the vibration member 80 and rotates the tray 20 relative to the base 30. The tray 20 rotates with the box body 10. When the latching member 50 vibrates up to a highest position, the limiting plate 51 abuts a bottom surface of the base 30, the tray 20 and the latching member 50 are located in a vibration position, and an angle is defined between the tray plate 21 and the base plate 31. In one embodiment, the angle is smaller than 30 degrees. The pills 100 move from the second side to the first side of the box body 10, when the tray 20 moves from the initial position to the vibration position. The tray 20 then rotates towards the base plate 31 until abutting the boss 313, and the box body 10 and the latching member 50 are moved back to the initial position. Thus, the pills 100 that are piled up can be evenly distributed, and the pills 100 which are stuck together, can be separated when the tray 20 moves between the initial position and the vibration position.

It is to be understood, however, that even though numerous characteristics and advantages have been set forth in the foregoing description of embodiments, together with details of the structures and functions of the embodiments, the disclosure is illustrative only and changes may be made in detail, especially in the matters of shape, size, and the arrangement of parts within the principles of the disclosure, to the full extent indicated by the broad general meaning of the terms in which the appended claims are expressed.

What is claimed is:

1. A pill box of an automatic pill dispenser, comprising:
a base;
a tray located on the base;
a box body secured to the tray and configured to receive a plurality of pills; and
a vibration member located under the tray and being vibratile to move the tray and the box body up and down relative to the base, to separate the plurality of pills.

2. The pill box of claim 1, wherein the vibration member is located under a side of the box body, and the vibration member vibrates the side of the box body for moving the plurality of pills to an opposite side of the box body.

3. The pill box of claim 1, wherein an end of the tray is movably mounted to the base.

4. The pill box of claim 1, wherein a first end of the tray is pivotably mounted to the base, and the vibration member is located under a second end of the tray.

5. The pill box of claim 4, wherein the tray comprises a tray plate and a pivoting portion located on the tray plate; the base comprises a base plate and a receiving portion located on the base plate, and the receiving portion defines a receiving slot and a cutout; and the pivoting portion is rotatably received in the receiving slot via the cutout.

6. The pill box of claim 5, further comprising a latching member connected to the vibration member, wherein the latching member is engaged with the second end of the tray.

7. The pill box of claim 6, wherein the base defines an opening; the latching member comprises a limiting plate, a mounting portion extending from the limiting plate, and a hook extending from the mounting portion; the mounting portion is movably received in the opening; and the hook and the limiting plate are located on two opposite sides of the tray plate.

8. The pill box of claim 7, wherein a gap is defined between the limiting plate and the tray plate for the tray vibrating along relative to the base.

9. The pill box of claim 7, wherein the mounting portion defines a mounting hole and a latching slot; a protrusion extends from the tray plate and received in the mounting hole; a limiting piece extends from the protrusion; a boss extends from the tray plate and defines a limiting slot; and the limiting piece is engagingly received in the limiting slot and the latching slot.

10. The pill box of claim 5, wherein the tray further comprises a latching block, the box body further comprises a mounting piece engaged with the latching block, and the mounting piece is located between the latching block and the tray plate.

11. A pill box of an automatic pill dispenser, comprising:
a base;
a tray with a first end movably mounted to the base;
a box body secured to the tray and configured to receive a plurality of pills;
a vibration member located under a second end of the tray; and
a latching member connecting the vibration member to the tray;
wherein the vibration member is vibratile to move the tray and the box body up and down relative to the base, to separate the plurality of pills.

12. The pill box of claim 11, wherein the vibration member is located under a side of the box body, and the vibration member vibrates the side of the box body to move the plurality of pills to an opposite side of the box body.

13. The pill box of claim 11, wherein the first end of the tray is pivotably mounted to the base.

14. The pill box of claim 11, wherein the tray comprises a tray plate and a pivoting portion located on the tray plate; the base comprises a base plate and a receiving portion located on the base plate, and the receiving portion defines a receiving slot and a cutout; and the pivoting portion is rotatably received in the receiving slot via the cutout.

15. The pill box of claim 14, further comprising a latching member connected to the vibration member, wherein the latching member is engaged with the second end of the tray.

16. The pill box of claim 15, wherein the base defines an opening; the latching member comprises a limiting plate, a mounting portion extending from the limiting plate, and a hook extending from the mounting portion; the mounting portion is movably received in the opening; and the hook and the limiting plate are located on two opposite sides of the tray plate.

17. The pill box of claim 16, wherein a gap is defined between the limiting plate and the tray plate for the tray vibrating along relative to the base.

18. The pill box of claim 16, wherein the mounting portion defines a mounting hole and a latching slot; a protrusion extends from the tray plate and is received in the mounting hole; a limiting piece extends from the protrusion; a boss extends from the tray plate and defines a limiting slot; and the limiting piece is engagingly received in the limiting slot and the latching slot.

19. The pill box of claim 14, wherein the tray further comprises a latching block, the box body further comprises a mounting piece engaged with the latching block, and the mounting piece is located between the latching block and the tray plate.
